(19) United States
(12) Patent Application Publication
(10) Pub. No.: US 2010/0067950 A1
(43) Pub. Date: Mar. 18, 2010

(54) Image Forming Apparatus, Photoreceptor Unit, and Transfer Belt Unit

(75) Inventors: Hiroshi TOYAMA, Shiojiri-shi (JP); Koichi KAMIJO, Matsumoto-shi (JP); Ken IKUMA, Suwa-shi (JP)

Correspondence Address: HOGAN & HARTSON L.L.P., 1999 AVENUE OF THE STARS, SUITE 1400, LOS ANGELES, CA, 90067, US

(73) Assignee: SEIKO EPSON CORPORATION, Tokyo (JP)

(21) Appl. No.: 12/552,993

(22) Filed: Sep. 2, 2009

(30) Foreign Application Priority Data
Sep. 16, 2008 (JP) 2008-236141

(51) Int. Cl. G03G 15/16

(52) U.S. Cl. 399/159; 399/313; 399/297

(57) ABSTRACT

An image forming apparatus includes: a latent image carrier; an exposure unit which forms a latent image on the latent image carrier; a developing unit which develops the latent image formed on the latent image carrier by the exposure unit using liquid developer; a squeeze roller which contacts the latent image carrier, and applies bias voltage to the latent image carrier after development by the developing unit; an electrification reducing light source which supplies light to the latent image carrier to which bias is applied by the squeeze roller; a transfer member which contacts the latent image carrier and receives the image transferred from the latent image carrier; and a reflection preventing member disposed between the transfer member and the electrification reducing light source.

### BACKGROUND

1. Technical Field

The present invention relates to an image forming apparatus which develops a latent image formed on a photoreceptor by liquid developer containing toner and carrier, transfers the image thus developed onto a medium such as recording sheet, and forms the image by fusing and fixing the toner image transferred on the medium. The invention further relates to a photoreceptor unit and a transfer belt unit included in the image forming apparatus.

2. Related Art

Various types of wet-type image forming apparatus have been proposed which develop a latent image by liquid developer having high viscosity and containing toner as solid components dispersed in liquid solvent to visualize an electrostatic latent image. The developer used by this type of wet-type image forming apparatus has solid components (toner particles) suspended in organic solvent (carrier liquid) having high viscosity and electric insulation such as silicon oil, mineral oil, and edible oil. The toner particles are extremely fine particles having particle diameter of about 1 μm. By using the fine toner particles, the wet-type image forming apparatus can provide images of higher quality than that of images produced by a dry-type image forming apparatus using powder toner particles having particle diameter of about 7 μm.

According to an image forming apparatus of the type using liquid developer, toner images formed on a photoreceptor are transferred to an intermediate transfer member through cataphoresis produced by applying potential difference between the photoreceptor surface and the intermediate transfer member. When the potential difference produced between the photoreceptor surface voltage and the intermediate transfer member voltage is excessively large, electric discharge is generated therebetween. This discharge causes image distortion, and thus lowers the image quality. Moreover, the discharge generated at the transfer section produces a discharge trace on the photoreceptor, and promotes deterioration of the photoreceptor.

For overcoming these problems, such an image forming apparatus has been proposed which prevents the discharge discussed above by controlling the voltage of the photoreceptor surface before transferring toner images formed on the photoreceptor to the intermediate transfer member. For example, JP-A-2003-270968 discloses a tandem-type electrophotographic system which disposes plural photoreceptors in respective colors around the intermediate transfer member and stacks color toner images on the intermediate transfer member to collectively transfer the images to the sheet. This electrophotographic system includes an image forming apparatus which controls surface voltage Vbg at the non image part on the photoreceptor such that relations |Vimg|<|Vbg| and |Vbg−Vtr|<Vlimit hold (Vimg: surface voltage at image part on the photoreceptor immediately before transfer to intermediate transfer member, Vbg: surface voltage at non image part immediately before transfer to intermediate transfer member, Vtr: voltage of intermediate transfer member, Vlimit: potential difference causing discharge between intermediate transfer member and photoreceptor).

A general structure of an image forming apparatus using liquid developer in related art proposed by the present inventors is herein discussed. FIG. 10 is a cross-sectional view of main constituent elements of an image forming unit of an image forming apparatus in related art. FIG. 10 shows a photoreceptor 10, a corona electrifier 11, an exposure unit 12, a first photoreceptor squeeze roller 13, a second photoreceptor squeeze roller 13′, a developing roller 20, an intermediate transfer member 40, and a primary transfer backup roller 51.

According to the image forming unit having this structure, the photoreceptor 10 is uniformly electrified by the corona electrifier 11, and an electrostatic latent image is formed on the electrified photoreceptor 10 in response to an inputted image signal under the control of the exposure unit 12. The electrostatic latent image part thus formed is developed by the developing roller 20 using liquid developer containing carrier and toner particles to become a developed image. In this specification, the part containing the developed image on the photoreceptor 10 is referred to as image part, and the part not containing the developed image is referred to as non image part.

A squeeze unit having the first photoreceptor squeeze roller 13 and the second photoreceptor squeeze roller 13′ has function of collecting carrier and unnecessary fog toner and raising the toner particle ratio in the developed image. For providing the function of collecting unnecessary fog toner to the squeeze unit, appropriate bias voltage is applied to the first photoreceptor squeeze roller 13 and the second photoreceptor squeeze roller 13′.

The surface of the photoreceptor 10 having passed the squeeze unit contacts the intermediate transfer member 40, where the toner image on the photoreceptor 10 is transferred to the intermediate transfer member 40 by the function of transfer bias Vt applied to the primary transfer backup roller 51.

The possibility of discharge at the primary transfer section is now discussed showing specific numerals as examples. The image part carrying toner particles on the surface of the photoreceptor 10 has surface voltage of about +50 V, and the non image part not carrying toner particles has surface voltage of about +600 V immediately after passing the second photoreceptor squeeze roller 13′ and before primary transfer. Also, the transfer bias Vt of −300 V is applied to the primary transfer backup roller 51.

In this case, Δv at the image part is 350 V, and Δv at the non-image part is 900 V in the primary transfer section. It is defined herein that ΔV=|Vs−Vt| (Vs: photoreceptor surface voltage immediately before primary transfer, Vt: transfer bias voltage).

When ΔV is close to about 1,000 V, the possibility of discharge generation in the primary transfer section increases. Thus, the possibility of discharge at the non image part having ΔV of about 900 V is extremely high.

For solving this problem, the present inventors proposed a structure including an electrification reducing light source unit 140 before the primary transfer in related art. According to this structure, the electrification reducing light source unit 140 applies light to the photoreceptor surface to decrease the electrified condition of the photoreceptor surface. FIG. 11 is a cross-sectional view showing main components of an image forming unit of an image forming apparatus having a discharge preventive element in the primary transfer section.

As described above, predetermined bias voltage is applied to the first photoreceptor squeeze roller 13 and the second photoreceptor squeeze roller 13′ contained in the squeeze unit to remove fog toner at the non image part. For example, fog toner at the non image part is removed by providing potential difference of 200 V between bias of 400 V applied to the second photoreceptor squeeze roller 13′ and the voltage (600 V) at the non image part on the photoreceptor 10.

When light enters a squeeze nip portion between the second photoreceptor squeeze roller 13′ and the photoreceptor 10 from the electrification reducing light source unit 140, voltage at the non image part lowers (to 550 V or lower, for example). In this case, desired potential difference cannot be produced between the second photoreceptor squeeze roller 13′ and the non image part, and fog toner cannot be accurately removed. When fog toner at the non image part is not properly removed, whiteness of the white part of the sheet decreases. Thus, the image quality lowers.

It is considered that the electrification reducing light source unit 140 is disposed in such a position as to prevent entrance of light into the nip portion from the electrification reducing light source unit 140. In this case, however, the photoreceptor 10 and the intermediate transfer member 40 to which liquid developer adheres function as mirror surfaces due to the presence of carrier in liquid developer, and irregularly reflect the light from the electrification reducing light source unit 140. As a result, light enters the squeeze nip portion.

### SUMMARY

It is an advantage of some aspects of the invention to provide a technology for solving the problems described above.

An image forming apparatus according to an aspect of the invention includes: a latent image carrier; an exposure unit which forms a latent image on the latent image carrier; a developing unit which develops the latent image formed on the latent image carrier by the exposure unit using liquid developer; a squeeze roller which contacts the latent image carrier, and applies bias voltage to the latent image carrier after development by the developing unit; an electrification reducing light source which supplies light to the latent image carrier to which bias is applied by the squeeze roller; a transfer member which contacts the latent image carrier and receives the image transferred from the latent image carrier; and a reflection preventing member disposed between the transfer member and the electrification reducing light source.

It is preferable that the reflection preventing member is disposed in such a position as to cross a virtual vertical plane passing the contact portion between the squeeze roller and the latent image carrier.

It is preferable that the electrification reducing light source is disposed in such a position that the optical axis of the electrification reducing light source has a positive elevation angle with respect to a virtual horizontal plane.

It is preferable that the transfer member is a belt, and that the belt is pressed against the latent image carrier by two rollers.

It is preferable that the surface of the reflection preventing member not opposed to the transfer member is a light absorbing surface.

A photoreceptor unit according to another aspect of the invention includes: a latent image carrier; a squeeze roller which contacts the latent image carrier, bias voltage being applied to the squeeze roller; an electrification reducing light source which supplies light to the latent image carrier; a reflection preventing member which prevents reflection of light emitted from the electrification reducing light source; and a supporting member which supports the latent image carrier, the squeeze roller, the electrification reducing light source, and the reflection preventing member.

A transfer belt unit according to still another aspect of the invention includes: a transfer belt member; an electrification reducing light source which supplies light; a reflection preventing member disposed between the transfer belt member and the electrification reducing light source; and a supporting member which supports the intermediate transfer belt, the electrification reducing light source, and the reflection preventing member.

According to the image forming apparatus, the photoreceptor unit, and the transfer belt unit of these aspects of the invention, generation of discharge at the transfer section can be prevented by providing the electrification reducing light source. Thus, deterioration of the image quality and the latent image carrier can be prevented. Moreover, light entering the squeeze nip portion is reduced by the reflection preventing member as well as the function of the electrification reducing light source. Thus, appropriate potential difference can be maintained between the non image part on the latent image carrier on the photoreceptor and the squeeze roller. Accordingly, unnecessary fog toner can be efficiently removed from the non image part, and lowering of the image quality caused by decreased whiteness of the white portion on the sheet can be prevented.

### BRIEF DESCRIPTION OF THE DRAWINGS

The invention will be described with reference to the accompanying drawings, wherein like numbers reference like elements.

FIG. 1 illustrates main constituent elements of an image forming apparatus according to an embodiment of the invention.

FIG. 2 is a cross-sectional view showing main constituent elements of an image forming area.

FIG. 3 illustrates a layout of components around an electrification reducing light source unit in the image forming apparatus according to the embodiment of the invention.

FIG. 4 is a cross-sectional view illustrating main constituent elements of an image forming area according to another embodiment of the invention.

FIG. 5 illustrates main constituent elements of an image forming apparatus according to a further embodiment of the invention.

FIG. 6 illustrates a general structure of an intermediate transfer unit included in the image forming apparatus according to the further embodiment.

FIG. 7 is a perspective view illustrating a chassis of an image forming apparatus according to a still further embodiment of the invention.

FIG. 8 illustrates main constituent elements of an image forming apparatus according to a still further embodiment of the invention.

FIG. 9 illustrates main constituent elements of an image forming apparatus according to a still further embodiment of the invention.

FIG. 10 is a cross-sectional view illustrating main constituent elements of an image forming area in an image forming apparatus in related art.

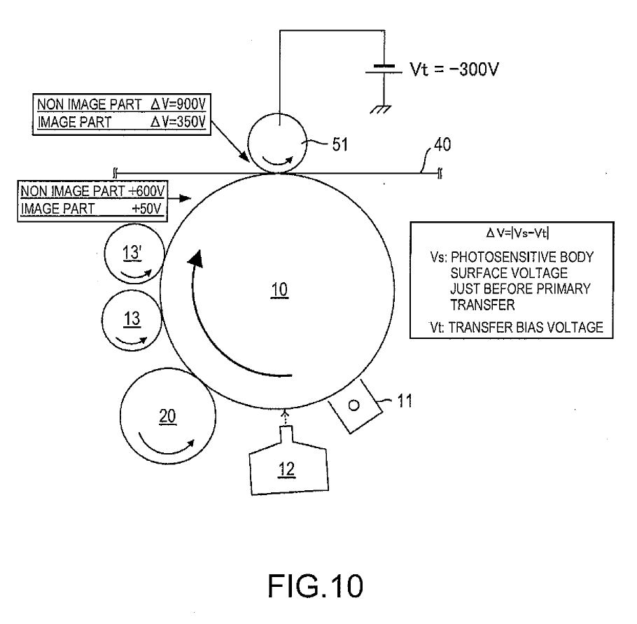

FIG. 11 is a cross-sectional view illustrating main components of an image forming unit in an image forming apparatus including a discharge preventive element in a primary transfer section.

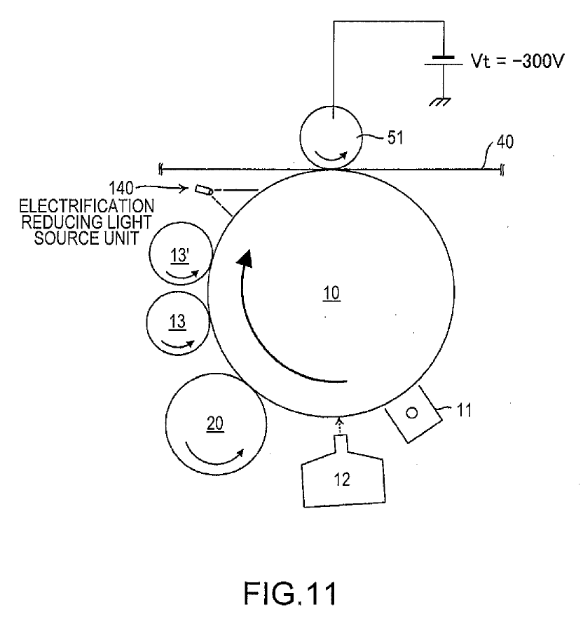

### DESCRIPTION OF EXEMPLARY EMBODIMENTS

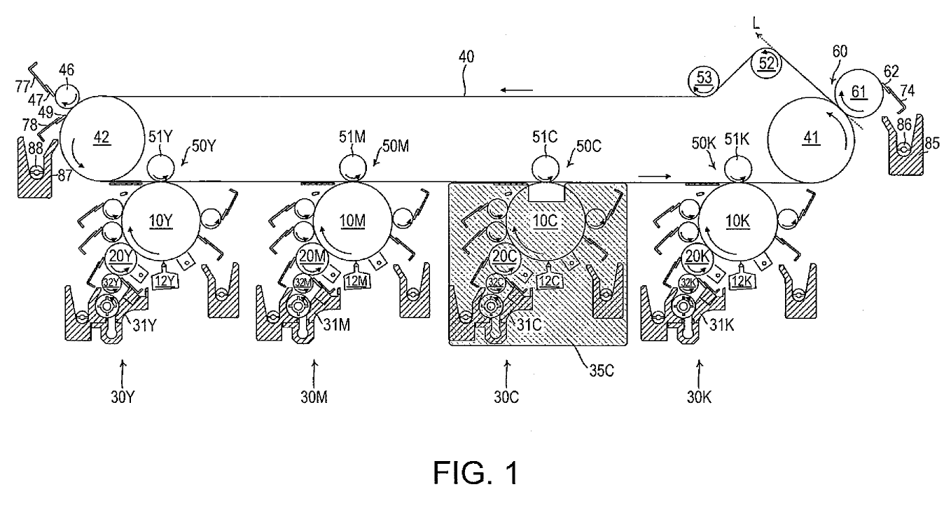

Exemplary embodiments according to the invention are hereinafter described with reference to the drawings. FIG. 1 illustrates main constituent elements of an image forming apparatus according to an embodiment of the invention. Developing devices 30Y, 30M, 30C, and 30K are positioned in the lower area of the image forming apparatus with respect to image forming areas in respective colors disposed in the central part of the image forming apparatus. An intermediate transfer member 40 and a secondary transfer section (secondary transfer unit) 60 are positioned in the upper part of the image forming apparatus.

The image forming areas include photoreceptors 10Y, 10M, 10C, and 10K, corona electrifiers 11Y, 11M, 11C, and 11K, not-shown exposure units 12Y, 12M, 12C, and 12K, and other components. Each of the exposure units 12Y, 12M, 12C, and 12K has organic EL element array (or LED array), a driver IC, and a wiring board. The image forming areas uniformly electrify the photoreceptors 10Y, 10M, 10C and 10K by using the corona electrifiers 11Y, 11M, 11C, and 11K, and form electrostatic images on the photoreceptors 10Y, 10M, 10C, and 10K thus electrified according to inputted image signals under the control of exposure units 12Y, 12M, 12C, and 12K.

The developing devices 30Y, 30M, 30C, and 30K chiefly include developing rollers 20Y, 20M, 20C, and 20K, developer containers (reservoirs) 31Y, 31M, 31C, and 31K for storing liquid developer in respective colors of yellow (Y), magenta (M), cyan (C), and black (K), anilox rollers 32Y, 32M, 32C, and 32K as rollers for applying liquid developer in respective colors stored in the developer containers 31Y, 31M, 31C and 31K to the developing rollers 20Y, 20M, 20C, and 20K, and other components. The developing devices 30Y, 30M, 30C, and 30K develop electrostatic latent images formed on the photoreceptors 10Y, 10M, 10C, and 10K using liquid developer in respective colors.

The intermediate transfer member 40 is an endless belt to be wound around a drive roller 41, and tension rollers 42, 52, and 53 with tension, and rotated by the drive roller 41 while contacting the photoreceptors 10Y, 10M, 10C, and 10K at primary transfer sections 50Y, 50M, 50C, and 50K. The primary transfer sections 50Y, 50M, 50C, and 50K are disposed opposed to primary transfer rollers 51Y, 51M, 51C, and 51K with the photoreceptors 10Y, 10M, 10C, and 10K and the intermediate transfer member 40 interposed between the primary transfer sections 50Y, 50M, 50C, and 50K and the primary transfer rollers 51Y, 51M, 51C, and 51K. The primary transfer sections 50Y, 50M, 50C, and 50K transfer toner images in respective colors developed and formed on the photoreceptors 10Y, 10M, 10C, and 10K to the intermediate transfer member 40 at the contact positions with the photoreceptors 10Y, 10M, 10C, and 10K as transfer positions after sequentially stacking the toner images on the intermediate transfer member 40 to form full-color toner images.

The secondary transfer unit 60 has a secondary transfer roller 61 opposed to the belt drive roller 41 with the intermediate transfer member 40 sandwiched between the secondary transfer roller 61 and the belt drive roller 41, and a cleaning device including a secondary transfer roller cleaning blade 62. The secondary transfer unit 60 transfers monochrome toner images or full-color toner images formed on the intermediate transfer member 40 to a recording medium such as sheet, film, and fabric fed through a sheet feeding path L at a transfer position where the secondary transfer roller 61 is located.

A not-shown fixing unit disposed in the downstream area of the sheet feeding path L fuses and fixes the monochrome toner images or full-color toner images transferred onto the recording medium such as sheet to the recording medium such as sheet.

The tension roller 42 and the belt drive roller 41 are components around which the intermediate transfer member 40 is wound. The cleaning device having the intermediate transfer member cleaning roller 46 contacts the intermediate transfer member 40 at the position where the intermediate transfer member 40 is wound around the tension roller 42.

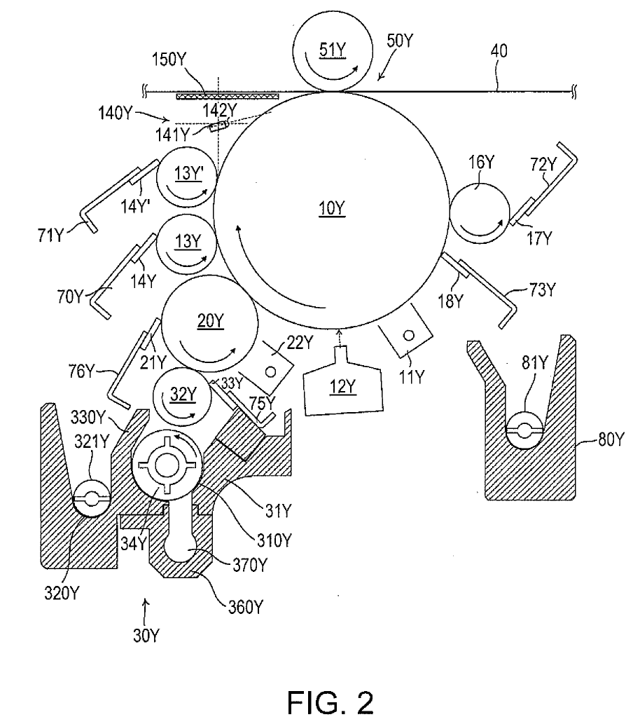

The image forming areas and developing devices of the image forming apparatus according to the embodiment of the invention are now described. FIG. 2 is a cross-sectional view showing main constituent elements of the image forming area and developing device. Since the image forming areas and developing devices have similar structures for each color, only the image forming area and developing device in yellow (Y) are discussed herein.

The image forming area includes a photoreceptor cleaning roller 16Y, a photoreceptor cleaning blade 18Y, a corona electrifier 11Y, an exposure unit 12Y, the developing roller 20Y of the developing device 30Y, a first photoreceptor squeeze roller 13Y, and a second photoreceptor squeeze roller 13Y′ disposed on the outer circumference of the photoreceptor 10Y in the rotation direction.

The photoreceptor cleaning roller 16Y having urethane rubber surface layer removes liquid developer after transfer or liquid developer before transfer from the photoreceptor 10Y by rotating anticlockwise while contacting the photoreceptor 10Y. Bias voltage for attracting toner particles in liquid developer is applied to the photoreceptor cleaning roller 16Y. Thus, the photoreceptor cleaning roller 16Y collects liquid developer containing a large volume of toner particles. The liquid developer rich in solid components collected by the photoreceptor cleaning roller 16Y is scraped by a photoreceptor cleaning roller cleaning blade 17Y contacting the photoreceptor cleaning roller 16Y to be dropped downward in the vertical direction.

On the downstream side of the photoreceptor cleaning roller 16Y, the photoreceptor cleaning blade 18Y contacting the photoreceptor 10Y drops the liquid developer rich in carrier components and remaining on the photoreceptor 10Y in the downward direction through a cleaning blade supporting member 73Y.

The liquid developer rich in solid components is liquid developer containing a larger volume of solid components than that of liquid developer supplied to the developing device 30Y. On the other hand, the liquid developer rich in carrier components is liquid developer containing a larger volume of carrier components than that of liquid developer supplied to the developing device 30Y. Liquid developer (toner) is defined as liquid containing solid components (toner particles) dispersed in carrier.

By mixing the liquid developer rich in solid components dropped from the photoreceptor cleaning roller cleaning blade 17Y and the liquid developer rich in carrier components scraped by the photoreceptor cleaning blade 18Y, the feeding efficiency of the cleaning blade supporting member 73Y improves. This improvement in feeding efficiency contributes to size reduction of the device.

A photoreceptor collecting storage unit 80Y has a concave portion for receiving both the liquid developer rich in solid components scraped by the photoreceptor cleaning roller cleaning blade 17Y and the liquid developer rich in carrier components scraped by the photoreceptor cleaning blade 18Y.

The concave portion of the photoreceptor collecting storage unit 80Y has a collecting screw 81Y to feed liquid developer received by the concave portion using spiral vanes of the collecting screw 81Y toward the rotation axis of the collecting screw 81Y in accordance with rotation of the collecting screw 81Y. The liquid developer conveyed by the collecting screw 81Y is supplied to a not-shown collecting mechanism.

Cleaning blade supporting members 70Y, 71Y, 72Y, and 73Y are cleaning blade supporting members for supporting the respective cleaning blades.

A cleaning blade 21Y, the anilox roller 32Y, and a compaction corona generator 22Y are disposed on the outer circumference of the developing roller 20Y in the developing device 30Y. A regulating blade 33Y for controlling the amount of liquid developer to be supplied to the developing roller 20Y contacts the anilox roller 32Y. A blade supporting member 75Y supports the regulating blade 33Y. An auger 34Y and a collecting screw 321Y are accommodated in the liquid developer container 31Y.

The primary transfer roller 51Y of the primary transfer section is disposed opposed to the photoreceptor 10Y along the intermediate transfer member 40.

The photoreceptor 10Y is a photoreceptor drum constituted by a cylindrical component having a width larger than that of the developing roller 20Y and a photoreceptor layer on the outer circumferential surface. The photoreceptor 10Y rotates clockwise as illustrated in FIG. 2, for example. The photoreceptor layer on the surface of the photoreceptor 10Y is constituted by amorphous silicon photoreceptor. The corona electrifier 11Y is disposed at a position upstream from the nip portion between the photoreceptor 10Y and the developing roller 20Y in the rotation direction of the photoreceptor 10Y. Voltage is applied to the corona electrifier 11Y by a not-shown power source device to provide corona-electrification on the photoreceptor 10Y. The exposure unit 12Y disposed at a position downstream from the corona electrifier 11Y in the rotation direction of the photoreceptor 10Y applies laser beam to the photoreceptor 10Y electrified by the corona electrifier 11Y to form a latent image on the photoreceptor 10Y.

It is defined that the structure including rollers and the like disposed in the earlier stage from the start to the end of the image forming process is positioned upstream from the structure including rollers and the like disposed in the later stage of the process.

The developing device 30Y has the compaction corona generator 22Y for providing compaction, and the developer container 31Y for storing liquid developer containing about 20% by weight of toner dispersed in carrier. The developer container 31Y has the collecting screw 321Y for collecting liquid developer not supplied to the anilox roller 32Y and the like.

The developing device 30Y includes the developing roller 20Y for carrying the liquid developer, the anilox roller 32Y as a roller for applying liquid developer to the developing roller 20Y, the regulating blade 33Y for regulating the amount of liquid developer applied to the developing roller 20Y, the auger 34Y for supplying liquid developer to the anilox roller 32Y while stirring and feeding the liquid developer, the compaction corona generator 22Y for bringing the liquid developer carried by the developing roller 20Y into compaction condition, and the developing roller cleaning blade 21Y for cleaning the developing roller 20Y. A cleaning blade supporting member 76Y supports the developing roller cleaning blade 21Y.

The liquid developer contained in the developing container 31Y is not volatile liquid developer having low concentration (about 1 to 2 wt %), low viscosity, and volatility at room temperature and containing Isopar (trademark of Exxon) generally used as carrier in related art, but non-volatile liquid developer having high concentration, high viscosity, and non-volatility at room temperature. More specifically, the liquid developer according to this embodiment is produced by adding solid components having the average particle diameter of 1 μm and containing colorant such as pigment dispersed in thermoplastic resin to liquid solvent such as organic solvent, silicon oil, mineral oil, and edible oil with dispersant such that the toner solid component concentration becomes about 20% with high viscosity (about 30 to 10,000 mPa·s).

The auger 34Y in the liquid developer container 31Y is disposed away from the anilox roller 32Y. Liquid developer is supplied to the anilox roller 32Y by anticlockwise rotation of the auger 34Y as viewed in FIG. 2.

The space in the developing container 31Y is divided into two parts by a portioning member 330Y. One of the parts divided by the portioning member 330Y is used as a supply storage portion 310Y for storing liquid developer to be supplied, and the other part is used as a collect storage portion 320Y for storing collected liquid developer. The supply storage portion 310Y and the collect storage portion 320Y are separated by the portioning member 330Y in such a manner as to be positioned in parallel with each other with respect to the axial direction.

The auger 34Y is rotatably attached to the supply storage portion 310Y. Liquid developer stored in the supply storage portion 310Y is supplied to the anilox roller 32Y by rotation of the auger 34Y during operation of the device. The supply storage portion 310Y is connected with a liquid developer supply pipe 370Y. Liquid developer is supplied to the supply storage portion 310Y through the liquid developer supply pipe 370Y.

The collecting screw 321Y is rotatably attached to the collect storage portion 320Y. Liquid developer not used for development, carrier dropped from cleaning blades such as the photoreceptor squeeze roller cleaning blades 14Y and 14Y′ are collected by rotation of the collecting screw 321Y during operation of the device.

The collect storage portion 320Y is connected with a liquid developer collect pipe 371Y. Liquid developer is conveyed to one end of the collect storage portion 320Y connected with the liquid developer collect pipe 371Y by rotation of the collect screw 321Y. By this method, the liquid developer collected by the collect storage portion 320Y is guided to a not-shown liquid developer recycle mechanism through the liquid developer collect pipe 371Y.

The anilox roller 32Y functions as a roller which supplies and applies liquid developer to the developing roller 20Y. The anilox roller 32Y is a cylindrical roller having concaves and convexes as grooves engraved in fine and uniform spiral shapes on the surface so as to easily carry developer on the surface. Liquid developer is supplied from the developer container 31Y to the developing roller 20Y by the function of the anilox roller 32Y. During operation of the device, liquid developer is supplied to the anilox roller 32Y by clockwise rotation of the auger 34Y as illustrated in FIG. 2. Then, the liquid developer is applied to the developing roller 20Y by anticlockwise rotation of the anilox roller 32Y.

The regulating blade 33Y is an elastic blade covered with elastic material on the surface. The regulating blade 33Y has a rubber portion formed by urethane rubber or the like to contact the surface of the anilox roller 32Y, and a plate made of metal or the like to support the rubber portion. The regulating blade 33Y controls the amount of liquid developer to be supplied to the developing roller 20Y by regulating and adjusting the thickness and volume of the liquid developer carried and fed by the anilox roller 32Y.

The developing roller cleaning blade 21Y is constituted by rubber or the like to contact the surface of the developing roller 20Y. The developing roller cleaning blade 21Y is disposed at a position downstream from the developing nip portion as contact portion between the developing roller 20Y and the photoreceptor 10Y in the rotation direction of the developing roller 20Y to scrape and remove the liquid developer remaining on the developing roller 20Y.

The compaction corona generator 22Y is an electric field applying unit for increasing electrifying bias on the surface of the developing roller 20Y. The compaction corona generator 22Y applies electric field to the liquid developer conveyed by the developing roller 20Y at the compaction portion in the direction from the compaction corona generator 22Y toward the developing roller 20Y as illustrated in FIG. 2.

The electric field applying unit for compaction may be a compaction roller or the like in place of the corona discharger for producing corona discharge shown in FIG. 2. This compaction roller is a cylindrical elastic roller covered with elastic material similarly to the developing roller 20Y. In this case, the compaction roller has conductive resin layer or rubber layer on the surface of a metal roller base material, and rotates in the clockwise direction opposite to the rotation direction of the developing roller 20Y, for example.

The developer carried on the developing roller 20Y and compacted is used for development in correspondence with the latent image on the photoreceptor 10Y by applying desired electric field at the developing nip portion as contact portion between the developing roller 20Y and the photoreceptor 10Y. The part on which the developed image exists on the photoreceptor 10 developed by the liquid developer is referred to as image part, and the part on which no developed image exists on the photoreceptor 10 is referred to as non image part.

The developer remaining after development is scraped and removed by the developing roller cleaning blade 21Y, and dropped into the collect portion in the developer container 31Y for reuse. The carrier and toner to be reused do not have color mixture.

The photoreceptor squeeze unit located on the upstream side of the primary transfer is disposed opposed to the photoreceptor 10Y and located on the downstream side of the developing roller 20Y to collect surplus developer on the toner image developed on the photoreceptor 10Y. As illustrated in FIG. 2, the photoreceptor squeeze unit includes the first photoreceptor squeeze roller 13Y and the second photoreceptor squeeze roller 13Y′ each of which has an elastic roller member covered with elastic material on the surface and slidingly contacting the photoreceptor 10Y during rotation, and the cleaning blades 14Y and 14Y′ for cleaning the surfaces of the first photoreceptor squeeze roller 13Y and the second photoreceptor squeeze roller 13Y′ by slidingly contacting the first and second photoreceptor squeeze rollers 13Y and 13Y′ with pressure. The photoreceptor squeeze unit has function of collecting surplus carrier and unnecessary fog toner from the developer after development of the photoreceptor 10Y to raise the toner particle ratio in the developed image. While the plural photoreceptor squeeze rollers 13Y and 13Y′ are provided as the photoreceptor squeeze unit before primary transfer in this embodiment, the photoreceptor squeeze unit may have only one photoreceptor squeeze roller. Alternatively, one of the plural photoreceptor squeeze rollers 13Y and 13Y′ may contact with and separate from the photoreceptor 10Y according to the condition of the liquid developer or the like.

Appropriate bias voltage is applied to each of the first photoreceptor squeeze roller 13Y and the second photoreceptor squeeze roller 13Y′ to collect unnecessary fog toner.

Illumination light is supplied from an electrification reducing light source unit 140Y to the surface of the photoreceptor 10Y having passed through the squeeze unit including the first photoreceptor squeeze roller 13Y and the second photoreceptor squeeze roller 13Y′ to decrease electrified condition of the surface of the photoreceptor 10Y. The electrification reducing light source unit 140Y includes a base 141Y extending in the axial direction of rollers, and electrification reducing light sources 142Y such as LED disposed on the base 141Y at appropriate intervals in the axial direction. The surface of the photoreceptor 10Y is uniformly illuminated in the axial direction by the electrification reducing light sources 142Y disposed as described above.

By illumination of the electrification reducing light source unit 140Y positioned before the primary transfer section 50Y, the voltage of the surface (particularly at the non image part) is reduced, and the potential difference from the primary transfer backup roller 51Y is decreased. Thus, generation of discharge at the primary transfer section can be reduced, and deterioration of the image quality and the photoreceptor can be prevented.

A reflection preventing member 150Y is disposed substantially just under the intermediate transfer member 40 and between the intermediate transfer member 40 and the electrification reducing light source unit 140Y. The reflection preventing member 150Y can block light reflected by the intermediate transfer member 40 due to adhesion of carrier oil contained in the liquid developer to the intermediate transfer member 40. The reflection preventing member 150Y is a plate-shaped component extending in the axial direction of the rollers. It is preferable that the reflection preventing member 150Y is manufactured from material easily absorbing light, or coated with paint easily absorbing light.

According to this embodiment, light entering the squeeze nip portion formed by the photoreceptor squeeze rollers 13Y and 13Y′ and the photoreceptor 10Y can be reduced by the reflection preventing member 150Y. Thus, appropriate potential difference between the non image part on the photoreceptor 10Y and the squeeze roller can be maintained. Accordingly, unnecessary fog toner can be efficiently removed from the non image part, and lowering of image quality due to decrease in whiteness of the white part of the sheet can be prevented.

The primary transfer section 50Y transfers the developed image on the photoreceptor 10Y to the intermediate transfer member 40 by using the primary transfer roller 51Y. At the primary transfer section, the toner image on the photoreceptor 10Y is transferred to the intermediate transfer member 40 by the function of the transfer bias Vt applied to the primary transfer backup roller 51. In this case, the photoreceptor 10Y and the intermediate transfer member 40 shift at equal speed, which reduces driving load for rotation and shift and prevents disturbance imposed on the developed toner image from the photoreceptor 10Y.

The intermediate transfer member 40 passes the nips in yellow (Y), magenta (M), cyan (C), and black (K) of the primary transfer section 50, receives the developed images transferred from the photoreceptors in respective colors, and stacks the images in respective colors. Then, the intermediate transfer member 40 enters the nip portion of the secondary transfer unit 60.

The intermediate transfer member 40 having passed the secondary transfer unit 60 again travels around to receive the transferred images at the primary transfer section 50. In this step, the intermediate transfer member 40 is cleaned by the intermediate transfer member cleaning roller 46 and the like on the upstream side of the operation of the primary transfer section 50.

The intermediate transfer member 40 has three-layer structure constituted by polyimide base layer, elastic intermediate layer of polyurethane disposed on the polyimide base layer, and PFA surface layer disposed on the elastic intermediate layer. The intermediate transfer member 40 having this structure is wound around the drive roller 41 and the tension rollers 42, 52, and 53 on the polyimide base layer side, and receives transferred toner images on the PFA surface layer side. The intermediate transfer member 40 having elasticity and constituted by this structure has high following and responsive property, and is thus effective for supplying and transferring toner particles having particularly small particle diameter to concaves of the recording medium.

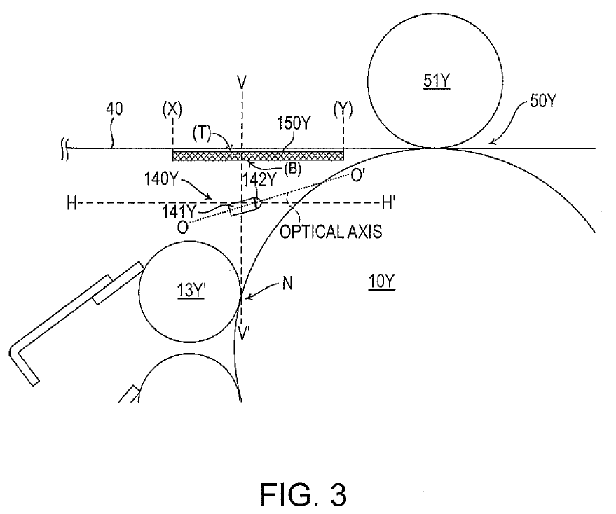

An ideal layout of the electrification reducing light source unit 140, the reflection preventing member 150 and other components is now discussed. FIG. 3 shows a layout of components around the electrification reducing light source unit in the image forming apparatus according to the embodiment of the invention.

In FIG. 3, a line V-V′ is a plane extending in the vertical direction and passing a squeeze nip N formed by the second photoreceptor squeeze roller 13Y′ and the photoreceptor 10Y. A line H-H′ is a horizontal plane passing the centers of the light emission portions of the electrification reducing light sources 142Y. A surface (T) is a surface of the reflection preventing member 150Y on the side opposed to the intermediate transfer member 40. A surface (B) is a surface of the reflection preventing member 150Y on the side not opposed to the intermediate transfer member 40. Ends (X) and (Y) represent the ends of the reflection preventing member 150Y. A line O-O′ is an optical axis of the electrification reducing light sources 142Y.

In this embodiment, the reflection preventing member 150Y is disposed in such a position as to cross at least the plane V-V′ extending in the vertical direction and passing the nip between the second photoreceptor squeeze roller 13Y′ and the photoreceptor 10Y. It is more preferable that one end (X) of the reflection preventing member 150Y extends to an area not receiving light entering from the light emission portions of the electrification reducing light sources 142Y, and that the other end (Y) of the reflection preventing member 150Y extends to an area close to the nip portion of the primary transfer section 50Y.

According to the arrangement described above, the reflection preventing member 150Y sufficiently blocks the light reflected by the intermediate transfer member 40, and thus reduces light entering the squeeze nip portion to maintain appropriate potential difference between the non image part on the photoreceptor and the squeeze roller. Accordingly, unnecessary fog toner on the non image part can be efficiently removed, and deterioration of image quality caused by lowered whiteness of the white portion of the sheet can be prevented.

In this embodiment, the electrification reducing light sources 142Y are disposed in such positions that the optical axis O-O′ of the electrification reducing light sources 142Y has a positive elevation angle with respect to the horizontal plane H-H′. In this case, light directly entering the squeeze nip portion from the electrification reducing light sources 142Y can be decreased. Thus, appropriate potential difference can be maintained at the squeeze nip portion, and fog toner can be adequately removed.

According to this embodiment, it is preferable that the surface (B) of the reflection preventing member 150Y not opposed to the intermediate transfer member 40 functions as a light absorbing surface. The surface (B) functioning as light absorbing surface is made of black synthetic resin material or the like, or produced by applying black paint to the surface (B) of the reflection preventing member 150Y. It is also preferable that the light absorbing surface is formed by a roughed surface, for example.

By providing the surface (B) not opposed to the intermediate transfer member 40 and functioning as light absorbing surface, reflection of light by the surface (B) of the reflection preventing member 150Y can be prevented, and light entering the squeeze nip portion can be reduced. Accordingly, appropriate potential difference can be maintained at the squeeze nip portion, and fog toner can be adequately removed.

The method of attaching the components such as electrification reducing light source unit 140 and the reflection preventing member 150 to the image forming apparatus is now discussed. The rollers and the like disposed around the photoreceptor 10 are combined with the photoreceptor 10 as one piece unit to be handled as a photoreceptor unit. Examples constituting the photoreceptor unit containing the photoreceptor 10 include the photoreceptor cleaning roller 16, the photoreceptor cleaning blade 18, the corona electrifier 11, the exposure unit 12, the developing roller 20 of the developing device 30, the first photoreceptor squeeze roller 13, and the second photoreceptor squeeze roller 13′. Other components may be combined as the photoreceptor unit.

The photoreceptor unit has two photoreceptor unit side plates 35 between which the photoreceptor 10 and other components are sandwiched from both ends of the photoreceptor unit in the axial direction. FIG. 1 shows the photoreceptor unit side plate 35C attached to the image forming area in cyan as an example of the photoreceptor unit side plates 35.

In this embodiment, at least the photoreceptor 10, the squeeze rollers 13, 13′, the base 141 of the electrification reducing light source unit 140, and the reflection preventing member 150 are attached to the photoreceptor unit side plates 35 of the photoreceptor unit to be combined as one piece unit. Since the electrification reducing light source unit 140 and the reflection preventing member 150 are combined with other components as one piece body of the photoreceptor unit, advantages such as easy handling during manufacture and easy maintenance can be provided.

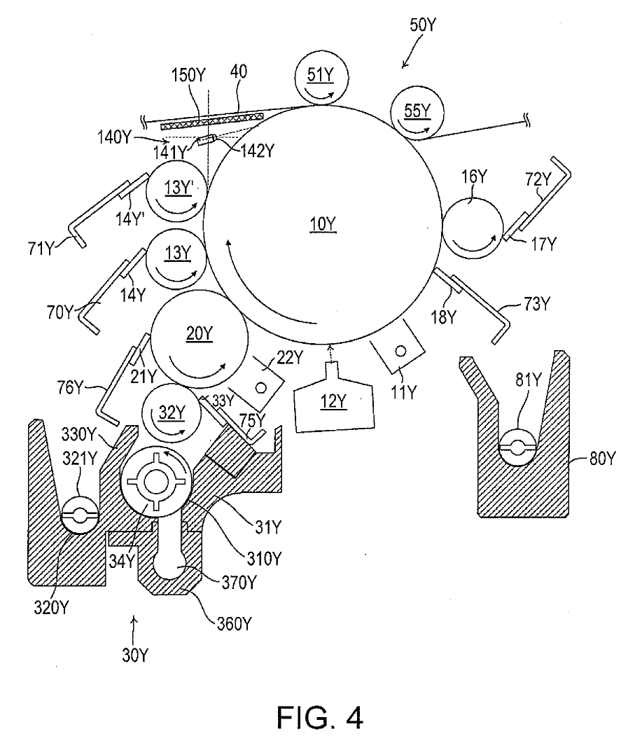

Another embodiment according to the invention is hereinafter described. FIG. 4 is a cross-sectional view illustrating main constituent elements of an image forming area according to this embodiment. The structure shown in FIG. 4 corresponds to the structure shown in FIG. 2. This embodiment is different from the embodiment described above in the structure of the primary transfer section. In the above embodiment, the primary transfer section is constituted by the nip portion between the photoreceptor 10Y and the primary transfer backup roller 51Y.

On the other hand, two backup rollers of the primary transfer backup roller 51Y and a second primary transfer backup roller 55Y are provided for the photoreceptor 10Y. The intermediate transfer member 40 is wound between the first nip portion formed by the photoreceptor 10Y and the primary transfer backup roller 51Y and the second nip portion formed by the photoreceptor 10Y and the second primary transfer backup roller 55Y. In this embodiment, the primary transfer section is formed between the first nip portion and the second nip portion. Bias voltage for the primary transfer section is applied to the primary transfer backup roller 51Y. When the bias voltage is applied to the primary transfer backup roller 51Y, the bias voltage applied between the first nip portion and the second nip portion is distributed due to resistance of the intermediate transfer member 40. As a result, toner particles are transferred while the intermediate transfer member 40 is passing through the two nip portions.

In this embodiment, similar to the embodiment described above, the illumination light is supplied from electrification reducing light source unit 140Y to the surface of the photoreceptor 10Y having passed through the second photoreceptor squeeze roller 13Y′ to decrease electrified condition of the surface of the photoreceptor 10Y.

By illumination from the electrification reducing light source unit 140Y before the primary transfer section 50Y, the surface voltage (particularly at the non image part) is reduced, and potential difference from the primary transfer backup roller 51Y is decreased. Thus, generation of discharge at the primary transfer section can be reduced, and deterioration of the image quality and the photoreceptor can be prevented.

The illumination from the electrification reducing light source unit 140Y reduces electrification, and has an effect on the transfer at the nip portion of the primary transfer section. According to this embodiment, transfer effect is produced for a relatively long distance between the first nip portion and the second nip portion. In this case, illumination does not reach the area after the first nip portion and before the second nip portion and thus does not affect this area. Accordingly, the effect of the illumination from the electrification reducing light source unit 140Y imposed on the primary transfer section can be reduced.

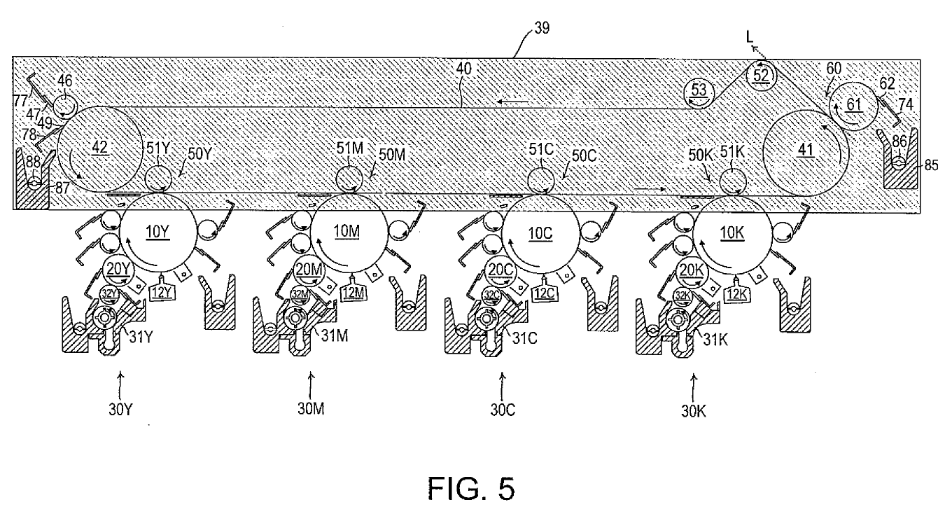

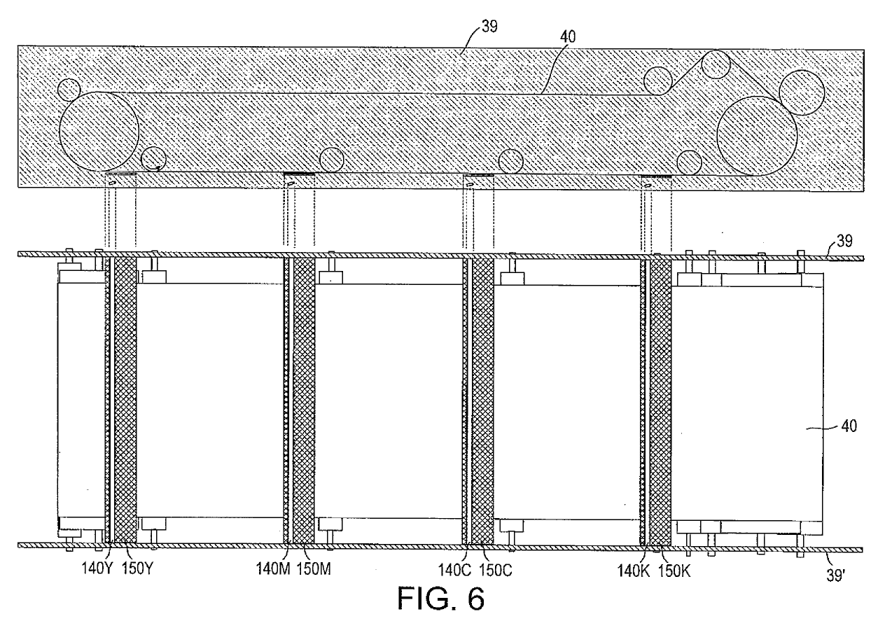

A further embodiment according to this invention is hereinafter described. FIG. 5 illustrates main constituent elements of an image forming apparatus according to this embodiment. FIG. 6 illustrates a general structure of an intermediate transfer unit included in the image forming apparatus according to this embodiment. In the above embodiments, the electrification reducing light source unit 140 and the reflection preventing member 150 are combined with the photoreceptor unit as one piece unit. According to this embodiment, however, the electrification reducing light source units 140 and the reflection preventing members 150 are attached to the intermediate transfer unit as one piece unit.

The intermediate transfer unit includes the intermediate transfer member 40, the belt drive roller 41, the tension roller 42, the tension roller 52, the tension roller 53, the primary transfer backup rollers 51Y, 51M, 51C, and 51K, and other components as one unit. The intermediate transfer unit is sandwiched between intermediate transfer unit side plates 39 and 39′ from both ends in the axis direction of the rollers. The upper part in FIG. 6 is a side view of the intermediate transfer unit, and the lower part of the figure shows the lower surface of the intermediate transfer unit.

According to this embodiment, the bases 141 of the electrification reducing light source units 140 and the reflection preventing members 150 as well as the components discussed are attached to the intermediate transfer unit side plates 39 and 39′ of the intermediate transfer unit as one body unit. Since the electrification reducing light source units 140 and the reflection preventing members 150 are combined with other components as one intermediate transfer unit in this embodiment, advantages such as easy handling during manufacture and easy maintenance can be provided.

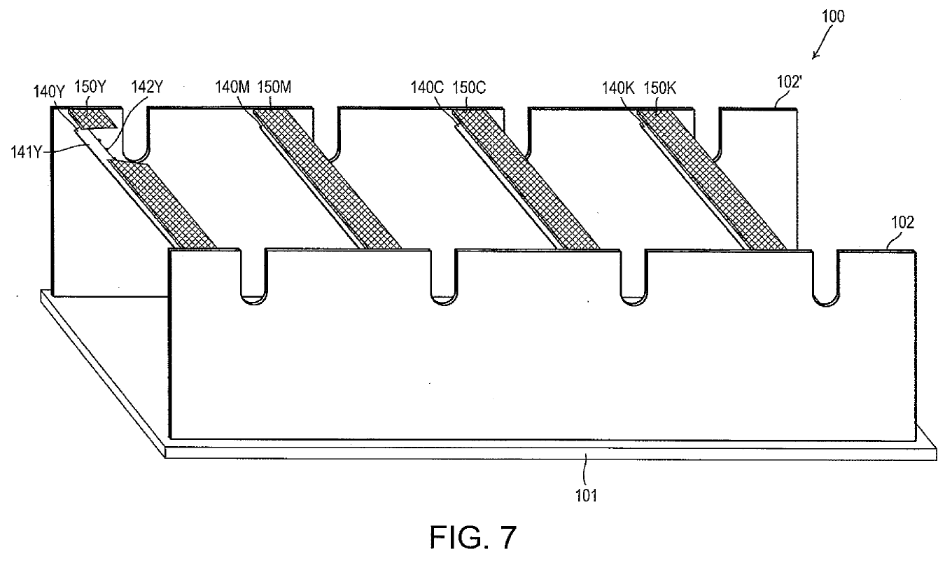

A still further embodiment of the invention is now described. FIG. 7 is a perspective view illustrating a chassis of an image forming apparatus in this embodiment. According to the above embodiments, the electrification light source unit 140 and the reflection preventing member 150 are attached to the photoreceptor unit or the intermediate transfer unit as one piece unit. However, these components are attached to a chassis 100 as the housing of the image forming apparatus as one piece unit in this embodiment. The chassis 100 includes a bottom plate 101 and two side plates 102 and 102′ projecting upward from the bottom plate 101. The electrification reducing light source units 140 and the reflection preventing members 150 are attached between the side plates 102 and 102′. Since the electrification reducing light source units 140 and the reflection preventing members 150 are combined with the chassis as one body unit in this embodiment, advantages such as easy handling during manufacture and easy maintenance can be provided.

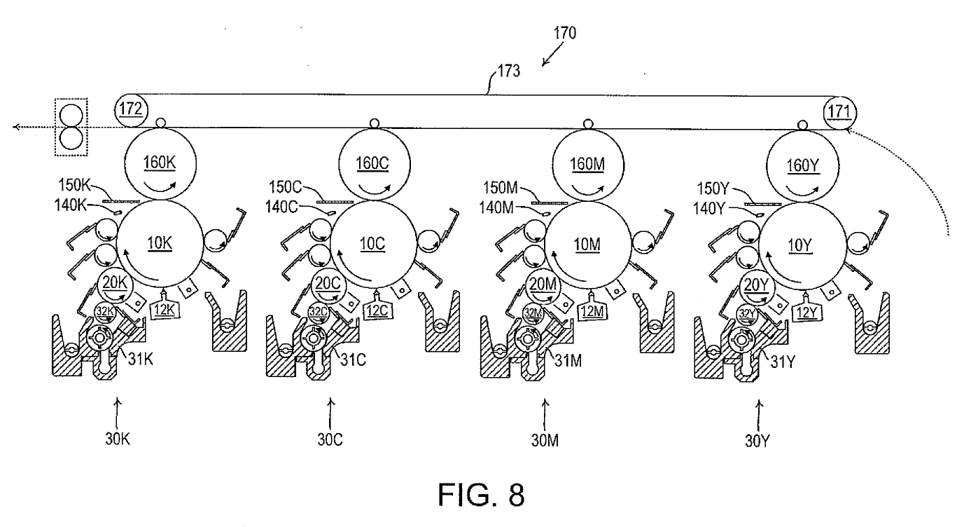

A still further embodiment of the invention is now described. FIG. 8 illustrates main constituent elements of an image forming apparatus in this embodiment. In the figure, similar reference numbers are given to parts similar to those in the above embodiments, and only the difference from the above embodiments is explained without repeating the same explanation. FIG. 8 shows intermediate transfer drums 160Y, 160M, 160C, and 160K, a sheet feed unit 170, a drive roller 171, a tension roller 172, and a sheet feed belt 173.

Developed toner images formed on the photoreceptors 10Y, 10M, 10C, and 10K in respective colors are transferred to the corresponding intermediate transfer drums 160Y, 160M, 160C, and 160K.

The sheet feed unit 170 has the loop-shaped endless sheet feed belt 173, the drive roller 171 around which the sheet feed belt 173 is wound such that the sheet feed belt 173 can be driven by the drive roller 171, and the tension roller 172 for giving tension to the sheet feed belt 173 in cooperation with the drive roller 171. The sheet feed unit 170 is a unit for feeding sheet by rotation of the sheet feet belt 173. Toner images on the intermediate transfer drums 160Y, 160M, 160C, and 160K are secondarily transferred to the sheet fed by the sheet feed unit 170.

In this structure, the electrification reducing light source units 140Y, 140M, 140C, and 140K, the reflection preventing members 150Y, 150M, 150C, and 150K, and other components are provided on the image forming areas in respective colors similarly to the above embodiments. According to this structure, light entering the squeeze nip portion is reduced, and appropriate potential difference between the non image part on the photoreceptor and the squeeze roller is maintained. Thus, unnecessary fog toner can be efficiently removed from the non image part, and lowering of image quality due to decreased whiteness of the white part of the sheet can be prevented.

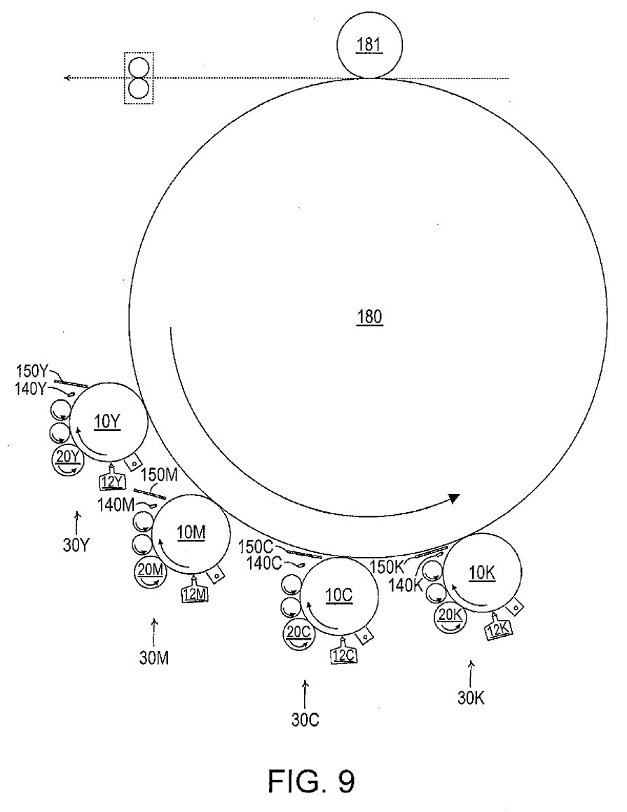

A still further embodiment of the invention is now discussed. FIG. 9 illustrates main constituent elements of an image forming apparatus in this embodiment. In the figure, similar reference numbers are given to parts similar to those in the above embodiments, and only the difference from the above embodiments is explained without repeating the same explanation. FIG. 9 shows an intermediate transfer drum 180 and a backup roller 181. Developed toner images formed on the photoreceptors 10Y, 10M, 10C, and 10K in respective colors are sequentially transferred to the intermediate transfer drum 180. Then, toner images stacked as full-color images are secondarily transferred to the sheet inserted into the nip formed between the intermediate transfer drum 180 and the backup roller 181.

According to the image forming apparatus having this structure, the electrification reducing light source units 140Y, 140M, 140C, and 140K, the reflection preventing members 150Y, 150M, 150C, and 150K, and other components are provided on the image forming areas in respective colors similarly to the above embodiments. In this structure, light entering the squeeze nip portion is reduced, and appropriate potential difference between the non image part on the photoreceptor and the squeeze roller is maintained. Thus, unnecessary fog toner can be efficiently removed from the non image part, and lowering of image quality due to decreased whiteness of the white part of the sheet can be prevented.

An experiment example of the invention is now described. As a comparison example, an image forming apparatus including only the electrification reducing light sources 142 which supply light for reducing electrification of the photoreceptor 10 was prepared. According to the comparison example having no reflection preventing member, OD value at the non image part was 0.20. According to the experiment example of the invention having the reflection preventing member, the OD value was 0.07. The OD value is an abbreviation of optical density, indicating scale of color density. For measuring OD value, Spectro-Densito-meter 530 (product name) manufactured by X-Light Co., Ltd. was used. It was confirmed that fog toner can be more efficiently removed from the non image part in the structure of the experiment example of the invention including the reflection preventing member based on the result that the OD value in the experiment example of the invention was decreased to 0.07.

While various embodiments and example have been discussed in this specification, it is intended that combinations of these examples are also included in the scope of the invention.

The entire disclosure of Japanese Patent Application No: 2008-236141, filed Sep. 16, 2008 is expressly incorporated by reference herein.

What is claimed is:

1. An image forming apparatus comprising:
a latent image carrier;
an exposure unit that forms a latent image on the latent image carrier;
a developing unit that develops the latent image formed on the latent image carrier by the exposure unit using liquid developer;
a squeeze roller that contacts the latent image carrier, and applies bias voltage to the latent image carrier after development by the developing unit;
an electrification reducing light source that supplies light to the latent image carrier to which bias is applied by the squeeze roller;
a transfer member that contacts the latent image carrier and receives the image transferred from the latent image carrier; and
a reflection preventing member disposed between the transfer member and the electrification reducing light source.

2. The image forming apparatus according to claim 1, wherein the reflection preventing member is disposed in such a position as to cross a virtual vertical plane passing the contact portion between the squeeze roller and the latent image carrier.

3. The image forming apparatus according to claim 1, wherein the electrification reducing light source is disposed in such a position that the optical axis of the electrification reducing light source has a positive elevation angle with respect to a virtual horizontal plane.

4. The image forming apparatus according to claim 1, wherein:
the transfer member is a belt; and
the belt is pressed against the latent image carrier by two rollers.

5. The image forming apparatus according to claim 1, wherein the surface of the reflection preventing member not opposed to the transfer member is a light absorbing surface.

6. A photoreceptor unit comprising:
a latent image carrier;
a squeeze roller that contacts the latent image carrier, bias voltage being applied to the squeeze roller;
an electrification reducing light source that supplies light to the latent image carrier;
a reflection preventing member which prevents reflection of light emitted from the electrification reducing light source; and
a supporting member that supports the latent image carrier, the squeeze roller, the electrification reducing light source, and the reflection preventing member.

7. A transfer belt unit comprising:
a transfer belt member;
an electrification reducing light source that supplies light;
a reflection preventing member disposed between the transfer belt member and the electrification reducing light source; and
a supporting member that supports the intermediate transfer belt, the electrification reducing light source, and the reflection preventing member.
